(19) United States
(12) Patent Application Publication
(10) Pub. No.: US 2010/0102168 A1
(43) Pub. Date: Apr. 29, 2010

(54) OFFSET ATTACHMENT BOSS FOR RIBBED STRUCTURES

(75) Inventors: David P. Gentile, Chandler, AZ (US); Albert Kang, Chandler, AZ (US); Justin A. Tanner, Queen Creek, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/258,153

(22) Filed: Oct. 24, 2008

(51) Int. Cl. B64C 1/12

(52) U.S. Cl. 244/119; 244/132; 244/117 R

(57) ABSTRACT

An offset attachment boss for ribbed structure and aircraft components. The ribbed structure including a first plurality of rib members and a second plurality of rib members configured to define a plurality of intersections. At least one offset attachment boss is formed at an intersection of at least one of the first plurality of rib members and at least one of the second plurality of rib members. An anchoring bore is formed in a central aspect of the at least one offset attachment boss and configured to receive a fastener.

### TECHNICAL FIELD

The present invention relates to aircraft and, more particularly, to load carrying ribbed structures for use in aircraft structures.

### BACKGROUND

Aircraft structures, including fuselages, wings, doors, and the like, typically include light-weight structural components configured to withstand loads exerted upon the components by structural skin coverings, or the like. In many instances, these light-weight structural components are in the form of internal rib members that increase stiffness and strength of the aircraft structures while keeping weight minimized. In order to increase the overall strength and stiffness of the aircraft structure, the thin structural skin or skins may be attached to the edges of the internal ribs with fasteners, ultimately increasing the section moment of inertia. Since an efficiently-designed internal rib is, by nature, relatively highly stressed, the addition of a fastener with its associated stress concentration can be problematic. To achieve the fastening of the thin structural skin to the internal rib structure, a fastener anchoring bore is typically formed in a small boss that is located on the centerline of a rib structure or at the intersection of the centerlines of two or more rib structures. The placement of the fastener anchoring bore directly in the load path of the rib or rib structures may result in high local stress in the area surrounding the fastener anchoring bore. To mitigate the high stress the thickness of the boss and/or rib is typically increased. Often times, this high stress area may result in fatigue and/or corrosion, and may require costly aircraft inspection, refurbishing and maintenance.

Accordingly, there is a need for a superior rib structure design that incorporates improved stress loading of the rib structure when fasteners are utilized to attach additional structural components to the rib structure, such as structural skins. In addition, there is a need for a rib structure design that is durable and minimizes fatigue failure, without increasing machining cost and complexity.

### BRIEF SUMMARY

The present invention provides a rib structure including an offset attachment boss having an opening defined therein for placement of a fastener.

In one embodiment, and by way of example only, there is provided a rib structure including a first plurality of rib members and a second plurality of rib members, wherein the first plurality of rib members and the second plurality of rib members intersect to define a plurality of intersections. The rib structure further including a plurality of offset attachment bosses. Each of the plurality of offset attachment bosses is formed at one of the plurality of intersections. An anchoring bore is formed in a central aspect of each of the plurality of offset attachment bosses and configured to receive a fastener.

In another exemplary embodiment, and by way of example only, there is provided a structural component including a primary structural skin, a rib structure, a secondary structural skin and at least one fastener. The primary structural skin includes an outer surface and an inner surface. The rib structure extends substantially perpendicular to the inner surface of the primary structural skin. The secondary structural skin is coupled to the rib structure in parallel relationship to the primary structural skin and includes an inner surface and an outer surface. The outer surface of each of the primary structural skin and the secondary structural skin are separated by a distance. The at least one fastener is configured to couple the secondary structural skin to the rib structure. The rib structure includes a first plurality of rib members and a second plurality of rib members configured intersecting with the first plurality of rib members and defining a plurality of intersections. At least one offset attachment boss is formed offset from at least one of the plurality of intersections formed by the at least one of the first plurality of rib members and at least one of the second plurality of rib members. An anchoring bore is formed in a central aspect of the at least one offset attachment boss and configured to receive the at least one fastener.

In yet another exemplary embodiment, and by way of example only, there is provided a structural component including a primary structural skin, a secondary structural skin, a rib structure and at least one fastener. The primary structural skin includes an outer surface and an inner surface. The rib structure is formed integral with the primary structural skin and extends substantially perpendicular to the inner surface of the primary structural skin. The secondary structural skin is coupled to the rib structure in parallel relationship to the primary structural skin and includes an inner surface and an outer surface. The outer surface of each of the primary structural skin and the secondary structural skin are separated by a distance. The at least one fastener is configured to couple the secondary structural skin to the rib structure. The rib structure includes a first plurality of rib members and a second plurality of rib members configured orthogonal to the first plurality of rib members and defining a plurality of intersections. The at least one offset attachment boss is formed offset from at least one of the plurality of intersections formed by the at least one of the first plurality of rib members and at least one of the second plurality of rib members. The rib structure further includes a threaded anchoring bore formed in a central aspect of the at least one offset attachment boss and into the at least one offset attachment boss in a downwardly direction. The threaded anchoring bore is configured to receive the at least one fastener.

Other independent features and advantages of the offset attachment boss for ribbed structures will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figure, wherein:

FIG. 1 is a three-dimensional view of an exemplary rib structure including a plurality of offset attachment bosses, according to an embodiment;

FIG. 2 is a plan view of a portion of a rib structure including a plurality of offset attachment bosses, according to an embodiment;

FIG. 3 is a plan view of a portion of a rib structure including a plurality of offset attachment bosses, according to an another embodiment; and

FIG. 4 is an enlarged partial, cross-sectional view taken through line 3-3 of FIG. 1, including a structural skin attached to the rib structure according to an embodiment.

### DETAILED DESCRIPTION

Before proceeding with the description, it is to be appreciated that the following detailed description is merely exemplary in nature and is not intended to limit the invention or the application and uses of the invention. Furthermore, there is no intention to be bound by any theory presented in the preceding background or the following detailed description.

The embodiment disclosed herein is described in sufficient detail to enable those skilled in the art to practice the invention, and it is to be understood that other embodiments may be utilized and that logical mechanical changes may be made without departing from the scope of the present invention. Furthermore, it will be understood by one of skilled in the art that although the specific embodiment illustrated below is directed at a structural rib component typically found in an aircraft, for purposes of explanation, the offloading design may be used in various other components employing lightweight internal support structures. The following detailed description is, therefore, not to be taken in a limiting sense.

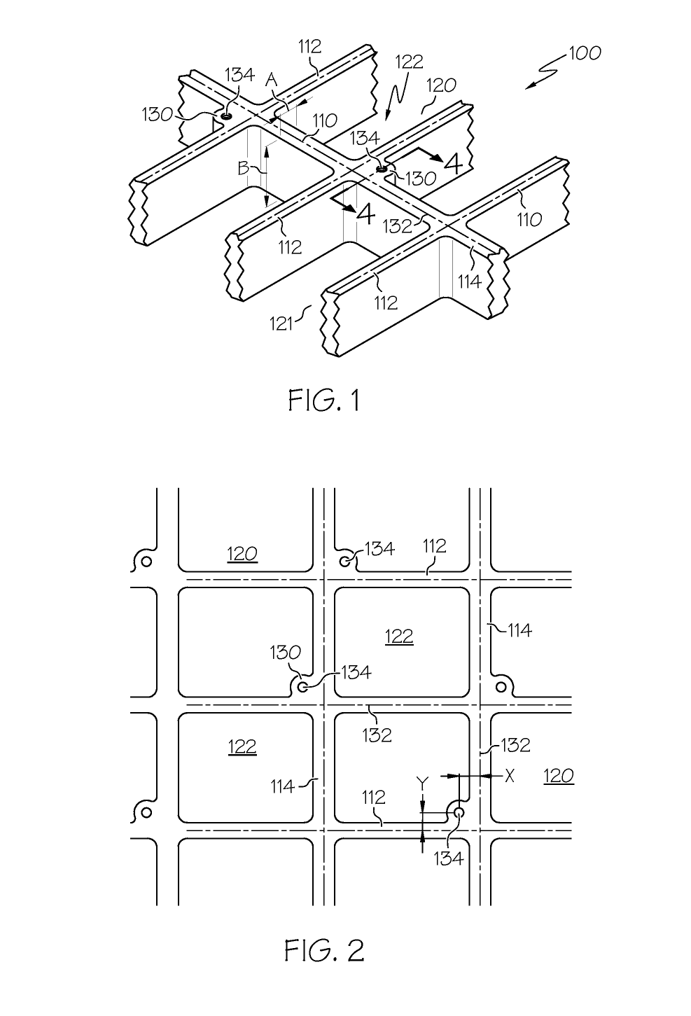

Turning now to FIGS. 1-2, illustrated in a three-dimensional and plan view, respectively, is a portion of an exemplary aircraft structure 100, according to an embodiment. The aircraft structure 100 includes a rib structure 110 configured to provide strength and stiffness to the aircraft structure 100, such as, but not limited to, a fuselage, a wing, passenger doors, cargo doors, valve doors, or the like. The rib structure 110 is formed as a support structure for a first structural skin 120 with which it is integrally formed as a part thereof, and a second structural skin (described presently) that is attached thereto. Typically, the rib structure 110 is machined out of a parent material as a single component structure that is integrally formed with the structural skin. More particularly, the rib structure 110 may be formed by machining material away from a thick sheet or plate of metal, such that the remaining material defines the first structural skin 120 and the rib structure 110. The machining process leaves a continuous smooth surface on one side, referred to as an outer surface 119 (FIG. 4), defining the first structural skin 120 and the rib structure 110 defining a series of pockets (described presently) on an inner surface 121. The rib structure 110 is generally comprised of a plurality of integrally formed rib members extending substantially perpendicular from a surface 121 of the first structural skin 120 configured to carry an inplane load. More specifically, the rib structure 110 as illustrated in FIGS. 1 and 2 includes a first plurality of rib members 112 and a second plurality of rib members 114 (of which only one is illustrated in FIG. 1) formed substantially perpendicular to the first plurality of rib members 112. As best illustrated in FIG. 4, the rib structure 110 may include the fabrication of a plurality of fillets 118 forming rounded interior angles where the rib structure 110 meets the first structural skin 120. The geometry of the rib structure 110, and more particularly the first plurality of rib members 112 and the second plurality of rib members 114 may vary in size and shape. In the illustrated embodiment, the first plurality of rib members 112 and the second plurality of rib members 114 are substantially rectangular having a first dimension “A” and a second dimension “B” perpendicular to the first dimension. In an alternate embodiment, the rib members may be substantially “I” shaped. In a preferred embodiment, each of the plurality of rib members 112 and 114 are designed according to a specific load (axial, bending, pressurization) and the desired moment of inertia required for the specific load.

As best illustrated in FIG. 2, the rib structure 110 and more particularly the first plurality of rib members 112 and the second plurality of rib members 114 may be configured such that a pocket 122 is formed between each corresponding pair of first plurality of rib members 112 and a pair of the orthogonally related second plurality of rib members 114. The pockets 122 are configured having a geometry capable of translating stress loads exerted upon the rib structure 110. More specifically, in this preferred embodiment the rib structure 110 defines the pockets 122 as substantially rectangular in shape, although other configurations suitable for the structural conditions and requirements may be utilized.

The rib structure 110 further includes a plurality of protrusions or offset attachment bosses 130 formed generally offset from a centerline (as indicated by a broken line) of each of the first plurality of rib members 112 and the second plurality of rib members 114. More specifically, during the machining process to define the rib structure 110, the plurality of offset attachment bosses 130 are defined in the material offset a distance from a centerline 132 of each of the plurality of first rib members 112 and the second plurality of rib members 114 as indicated in FIG. 2. More particularly, each of the offset attachment bosses 130 is a machined boss having a first centerline parallel to and a distance “X” from a centerline of a first rib member 112 and a second centerline parallel to and a distance “Y” from a centerline of a second rib member 114, wherein “X” and “Y” are less than a distance between a plurality of first rib members 112 and less than a distance between a plurality of second rib members 114.

It should be understood that while only two offset attachment bosses 130 are illustrated in FIG. 1 and five offset attachment bosses 130 are illustrated in FIG. 2, any number of offset attachment bosses 130 may be configured integral with the rib structure 110, and in any location relative to the intersection of the first and second pluralities of rib members 112 and 114 dependent on the specific structural conditions and load offset requirements.

Each of the plurality of offset attachment bosses 130 has an anchoring bore 134 defined in a central aspect. The anchoring bore 134 is configured to receive a fastener for securing a second structural skin (described presently) to the rib structure 110. More specifically, each of the plurality of anchoring bores 134 is sized to receive a tension fastener therein.

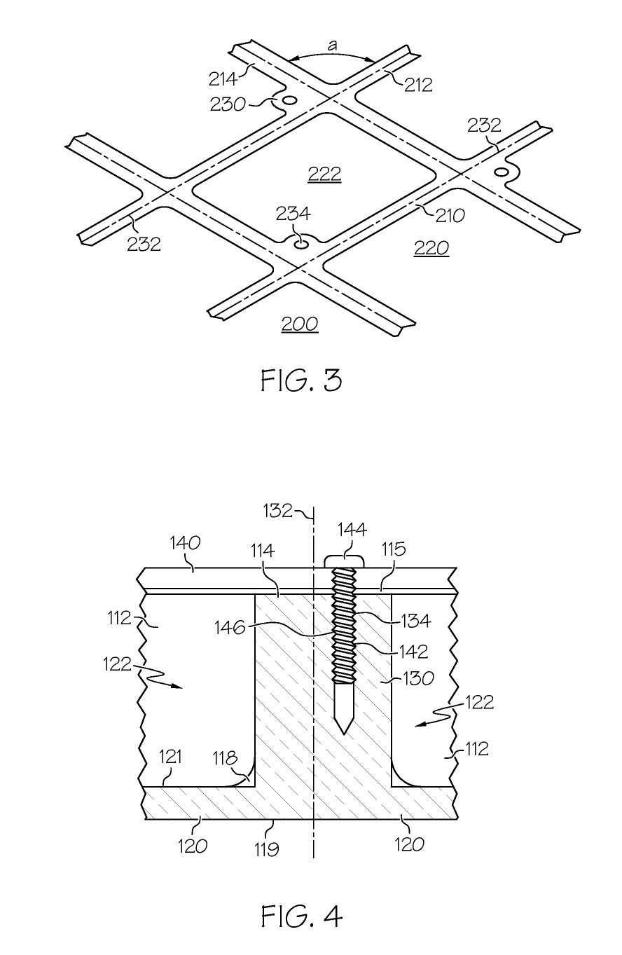

Referring now to FIG. 3, illustrated in plan view, is a portion of an exemplary aircraft structure 200, including a rib structure 210, according to another embodiment. The rib structure 210 is generally comprised of a plurality of integrally formed rib members extending substantially perpendicular from a surface of a first structural skin 220. The rib structure 210 is comprised of a first plurality of rib members 212 and a second plurality of rib members 214. As previously stated with respect to the first embodiment, the geometry of the rib structure 210, and more particularly the first plurality of rib members 212 and the second plurality of rib members 214 may vary in size and shape. In this particular embodiment, the first plurality of rib members 212 are formed at an angle “a” to the second plurality of rib members 214, where the angle “a” is not equal to 90°. More specifically, in contrast to the rib structure 110 described with reference to FIGS. 1-2, the rib structure 210, and more particularly the first plurality of rib members 212 are not configured orthogonal to the second plurality of rib members 214.

In this particular embodiment the rib structure 210 and more particularly the first plurality of rib members 212 and the second plurality of rib members 214 may be configured such that a pocket 222 is formed between each corresponding pair of first plurality of rib members 212 and a pair of related second plurality of rib members 214. The pockets 222 are configured having a geometry capable of translating stress loads exerted upon the rib structure 210.

The rib structure 210 further includes a plurality of protrusions or offset attachment bosses 230, similar to offset attachment bosses 130 of FIGS. 1-2, formed generally offset from a centerline 232 (as indicated by a broken line) of each of the first plurality of rib members 212 and the second plurality of rib members 214. The plurality of offset attachment bosses 230 are defined in a machining process in a manner previously described with respect to offset attachment bosses 130 of FIGS. 1-2. It should be understood that while only three offset attachment bosses 230 are illustrated in FIG. 3, any number of offset attachment bosses 230 may be configured integral with the rib structure 210, and in any location relative to the intersections of the first and second pluralities of rib members 212 and 214 dependent on the specific structural conditions and load offset requirements.

Each of the plurality of offset attachment bosses 230 has an anchoring bore 234 defined in a central aspect. The anchoring bore 234 is configured to receive a fastener for securing a second structural skin (described presently) to the rib structure 210. More specifically, each of the plurality of anchoring bores 234 is sized to receive a tension fastener therein.

Turning now to FIG. 4, illustrated is an enlarged partial, cross-sectional view taken through line 4-4 of FIG. 1. A single offset attachment boss 130 is illustrated in one of the second plurality of rib members 114. In the illustrated embodiment, a second structural skin 140 is illustrated as being attached to an edge 115 of the rib member 114. In this particular embodiment, the edge 115 is illustrated as having a generally planar surface, but may include slightly rounded edges defining a slightly curved edge surface. The structural skin 140 may be formed of a metal or a composite material and provides further strengthening and stiffening of the overall panel structure 100. Each of the plurality of anchoring bores 134 may include a plurality of helical threads 142 so as to retain and secure a fastener 144 having reciprocating threads 146, or configured with close tolerances so as to retain a fastener via a tap or compression fit. The anchoring bore 134 is formed in each of the plurality of offset attachment bosses 130 in a downwardly direction into the offset attachment boss 130 without penetrating the first structural skin 120 and to a depth necessary to secure and retain the fastener 144.

The plurality of offset attachment bosses 130 and plurality of anchoring bores 134 configured therein each of the plurality of offset attachment bosses 130 provides for a load path that is offset from the main structural rib components, and more specifically the first plurality of rib members 112 and the second plurality of rib members 114. The offset of the load path enables the in-plane load to be carried by the rib structure 110 without interruption or interference. The offset of the load path minimizes stress concentration around each of the plurality of anchoring bores 134 and potential fatigue issues as a result thereof. In addition, a more weigh efficient structure is produced with a minimal impact on machining costs.

Accordingly, disclosed is an offset attachment boss for ribbed structures in which an offset attachment boss is fabricated offset a distance from a centerline of an intersection of two rib members. The offset attachment boss includes an anchoring bore formed therein a central aspect and sized to receive a fastener. The offsetting of the attachment structure enables the in-plane load path to be carried by the rib structure without interruption or interference. The end result is a light-weight structure that is susceptible to minimal stress concentrations.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. A rib structure comprising:
a first plurality of rib members;
a second plurality of rib members, wherein the first plurality of rib members and the second plurality of rib members intersect to define a plurality of intersections;
a plurality of offset attachment bosses, each of the plurality of offset attachment bosses formed at one of the plurality of intersections; and
an anchoring bore formed in a central aspect of each of the plurality of offset attachment bosses and configured to receive a fastener.

2. A rib structure as claimed in claim 1, wherein the first plurality of rib members and the second plurality of rib members are substantially rectangular having a first dimension and a second dimension substantially perpendicular to the first dimension.

3. A rib structure as claimed in claim 1, wherein the second dimension is greater than the first dimension.

4. A rib structure as claimed in claim 1, wherein the first plurality of rib members and the second plurality of rib members include an uppermost edge.

5. A rib structure as claimed in claim 1, wherein the anchoring bore formed in each of the plurality of offset attachment bosses includes a plurality of threads.

6. A rib structure as claimed in claim 1, wherein each of the plurality of offset attachment bosses is a machined boss having a first centerline parallel to and a distance “X” from a centerline of a first rib member and a second centerline parallel to and a distance “Y” from a centerline of a second rib member, wherein “X” and “Y” are less than a distance between a plurality of the first plurality of rib members and less than a distance between a plurality of the second plurality of rib members.

7. A rib structure as claimed in claim 1, wherein the rib structure is a machined structure.

8. A rib structure as claimed in claim 1, wherein the anchoring bore is configured into each of the plurality of offset attachment bosses in a downwardly direction.

9. A rib structure as claimed in claim 1, wherein the rib structure is formed integral with a first structural skin component configured to carry an inplane load.

10. A rib structure as claimed in claim 9, wherein the rib structure is produced according to a method comprising integrally forming the rib structure and the first structural skin component as a single component structure.

11. A structural component comprising:
a primary structural skin including an outer surface and an inner surface;
a rib structure extending substantially perpendicular to the inner surface of the primary structural skin;
a secondary structural skin coupled to the rib structure in parallel relationship to the primary structural skin and including an inner surface and an outer surface, wherein the outer surface of each of the primary structural skin and the secondary structural skin are separated by a distance; and
at least one fastener configured to couple the secondary structural skin to the rib structure,
the rib structure comprising:
a first plurality of rib members;
a second plurality of rib members configured intersecting with the first plurality of rib members and defining a plurality of intersections;
at least one offset attachment boss formed offset from at least one of the plurality of intersections formed by the at least one of the first plurality of rib members and at least one of the second plurality of rib members; and
an anchoring bore formed in a central aspect of the at least one offset attachment boss and configured to receive the at least one fastener.

12. A structural component as claimed in claim 11, wherein the anchoring bore formed in the at least one offset attachment boss includes a plurality of threads.

13. A structural component as claimed in claim 11, wherein the at least one offset attachment boss is a machined boss having a first centerline parallel to and a distance “X” from a centerline of a first rib member and a second centerline parallel to and a distance “YY” from a centerline of a second rib member, wherein “X” and “Y” are less than a distance between a plurality of the first plurality of rib members and less than a distance between a plurality of the second plurality of rib members.

14. A structural component as claimed in claim 11, wherein the first plurality of rib members are configured orthogonal to the second plurality of rib members.

15. A structural component as claimed in claim 11, wherein the anchoring bore is configured into the at least one offset attachment boss in a downwardly direction.

16. A rib structure as claimed in claim 11, further comprising at least one pocket defined between at least two of the first plurality of rib members and at least two of the second plurality of rib members.

17. A rib structure as claimed in claim 11, wherein the rib structure is formed integral with a first structural skin component configured to carry an inplane load.

18. A structural component comprising:
a primary structural skin including an outer surface and an inner surface;
a rib structure formed integral with the primary structural skin and extending substantially perpendicular to the inner surface of the primary structural skin;
a secondary structural skin coupled to the rib structure in parallel relationship to the primary structural skin and including an inner surface and an outer surface, wherein the outer surface of each of the primary structural skin and the secondary structural skin are separated by a distance; and
at least one fastener configured to couple the secondary structural skin to the rib structure,
the rib structure comprising:
a first plurality of rib members;
a second plurality of rib members configured orthogonal to the first plurality of rib members and defining a plurality of intersections;
at least one offset attachment boss formed offset from at least one of the plurality of intersections formed by the at least one of the first plurality of rib members and at least one of the second plurality of rib members; and
a threaded anchoring bore formed in a central aspect of the at least one offset attachment boss and into the at least one offset attachment boss in a downwardly direction,
wherein the threaded anchoring bore is configured to receive the at least one fastener.

19. A structural component as claimed in claim 18, wherein the at least one offset attachment boss is a machined boss having a first centerline parallel to and a distance “X” from a centerline of a first rib member and a second centerline parallel to and a distance “Y” from a centerline of a second rib member, wherein “X” and “Y” are less than a distance between a plurality of first rib members and less than a distance between a plurality of second rib members.

20. A structural component as claimed in claim 18, wherein the rib structure is a machined structure.
